(19) United States
(12) Patent Application Publication
(10) Pub. No.: US 2023/0035666 A1
(43) Pub. Date: Feb. 2, 2023

(54) ANOMALY DETECTION IN STORAGE SYSTEMS

(71) Applicant: Seagate Technology LLC, Fremont, CA (US)

(72) Inventors: Anatolii Bilenko, Kyiv (UA); Yuriy V. Umanets, Kyiv (UA); Maksym Medvied, Moscow (RU)

(21) Appl. No.: 17/391,463

(22) Filed: Aug. 2, 2021

(51) Int. Cl. G06F 11/30; G06F 11/34; G06F 11/32; G06N 3/08

(52) U.S. Cl. CPC G06F 11/3034; G06F 11/3414; G06F 11/323; G06N 3/08

(57) ABSTRACT

A method of preparing an input vector for a neural network includes capturing a plurality of information about a storage system, including workload types, a processing graph, and read/write histograms, and creating a correlation matrix from processing times of different levels of processes in a workload of the storage system. The input vector is prepared with a workload vector representing the workload types, a behavior matrix representing the processing graph, a read/write histogram shape matrix representing the read/write histograms, and the correlation matrix.

### SUMMARY

In one embodiment, a method of preparing an input vector for a neural network includes capturing a plurality of information about a storage system, including workload types, a processing graph, and read/write histograms, and creating a correlation matrix from processing times of different levels of processes in a workload of the storage system. The input vector is prepared with a workload vector representing the workload types, a behavior matrix representing the processing graph, a read/write histogram shape matrix representing the read/write histograms, and the correlation matrix.

In another embodiment, a method includes monitoring a storage system workload and capturing storage system information including workload types, a processing graph, read/write histograms, and input/output performance, and predicting possible storage system anomalies based on the storage system workload and storage system information. A confidence level for the predicted possible anomalies is identified, and a type of anomaly for the predicted possible storage system anomalies, and an affected system property for the predicted anomalies is identified.

In another embodiment, a non-transitory computer-readable storage medium including instructions that cause a data storage device to capture a plurality of information about a storage system, including workload types, a processing graph, and read/write histograms, to create a correlation matrix from processing times of different levels of processes in a workload of the storage system, and to prepare the input vector with a workload vector representing the workload types, a behavior matrix representing the processing graph, a read/write histogram shape matrix representing the read/write histograms, and the correlation matrix.

This summary is not intended to describe each disclosed embodiment or every implementation of anomaly detection in storage systems as described herein. Many other novel advantages, features, and relationships will become apparent as this description proceeds. The figures and the description that follow more particularly exemplify illustrative embodiments.

### BRIEF DESCRIPTION OF THE DRAWINGS

FIG. 1 is a diagrammatic illustration of an example of a general architecture of a neural network;

FIG. 2 is a graph view of partially captured workloads according to an embodiment of the present disclosure;

FIG. 3 is a view of a representative processing graph according to an embodiment of the present disclosure;

FIG. 4 is a graph of a system write request with timelines of corresponding subrequests according to an embodiment of the present disclosure;

FIG. 5 is a more detailed graph of a timeline of a subevent of the system write request of FIG. 4;

FIG. 6 is a view of a representative histogram according to an embodiment of the present disclosure;

FIG. 7 is a timeline graph showing time intervals for principal components of subrequests of a representative, used for generating a correlation matrix according to an embodiment of the present disclosure;

FIG. 8 is an example of a correlation matrix structure;

FIG. 9 is a flow chart diagram of a method according to an embodiment of the present disclosure; and

FIG. 10 is a flow chart diagram of method according to another embodiment of the present disclosure.

### DETAILED DESCRIPTION OF ILLUSTRATIVE EMBODIMENTS

In modern backup systems with very large input/output (I/O) and multiple filesystem levels of processing I/O requests, it becomes very important to monitor system efficiency and to have ways to forecast possible issues. Since these types of systems are very complex, the probability of issues is quite high and the complexity of logs analysis does not allow this to normally be carried out easily and on time.

Embodiments of the disclosure generally provide analysis of I/O requests and operation of a large scale backup system, and prediction of anomalies, using a variety of tools. In addition, a confidence level for the anomalies, as well as an indication of what system property or properties may be affected are also identified. The embodiments do this using, for example, a neural network and machine intelligence, a forecasting module with workload types, processing graphs, read/write histograms, correlations and a correlation matrix to provide an input vector to the neural network. Then, given proper training, predictive nature and the assessment of confidence levels for predicted anomalies is provided through the neural network.

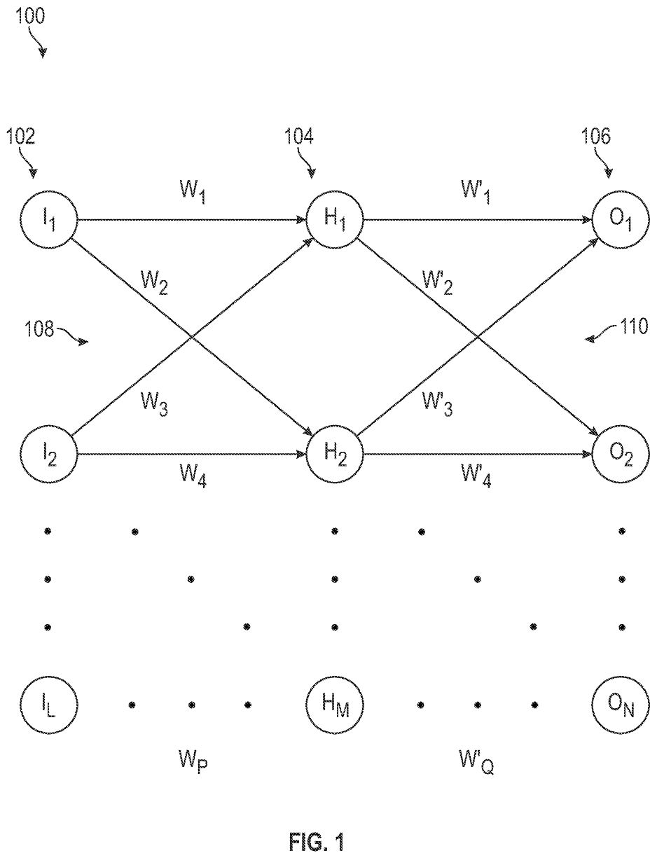

By gathering system logs with information, as described below, and training a neural network, the input vector to the neural network allows the neural network to be used to predict and generate a confidence level in future anomalies. Data gathered and determined by a method according to embodiments of the disclosure includes many types of system data, including, for example, workload types, processing graphs, read/write histograms, and a correlation matrix. Using large amounts of training samples of anomalous and non-anomalous conditions, a neural network can predict anomalies, and identify particular anomalies and workload types associated therewith. The embodiments of the disclosure may be used to predict and generate a confidence level in future anomalies. Since aspects of the disclosure are implemented with neural networks, a general architecture of a neural network is briefly described below in connection with FIG. 1

It should be noted that the same reference numerals are used in different figures for same or similar elements. It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

FIG. 1 is a diagrammatic illustration of an example of a general architecture of a neural network. Neural network 100 of FIG. 1 includes an input layer 102, a hidden layer 104 and an output layer 106. In the interest of simplification, only one hidden layer 104 is shown. However, in different artificial intelligence systems, any suitable number of hidden layers 104 may be employed. Input layer 102 includes input nodes I₁-I_{L}, hidden layer 104 includes hidden nodes H₁-H_{M} and output layer 106 includes output nodes O₁-O_{N}. Connections 108 and 110 are weighted relationships between nodes of one layer to nodes of another layer. Weights of the different connections are represented by W₁-W_{P} for connection 108 and W′₁-W′_{Q} for connections 110. Some embodiments relate to generating input vectors for a neural network (e.g., vectors that may be input to nodes I₁-I_{L}) to detect anomalies in a distributed data storage system. Other embodiments related to an analysis of the detected anomalies obtained at the output of the neural network (e.g., output nodes O₁-O_{N}) in response to the input vectors being provided to the input nodes I₁-I_{L}.

As will be apparent from the description further below, in operation, embodiments of the present disclosure provide, for example, the following advantages and components:

1) A characteristics matrix based on correlations for request flow processing times;

2) Neural network for predicting system anomalies, taking into account complex descriptors of the system state;

3) Distributed systems of a similar scale are not generally available due to their expense and complexity and, as a result, in this area not many good tools for analysis of control or/and data flow. Hence, there is no good understanding of the significance of the metrics of large scale distribute storage systems;

4) Since systems having the scale of large distributed storage systems are not common, and are generally not available to many, it is difficult to gather all the data used for training the network. Accordingly, neural networks have not been used for such processes.

In one embodiment, a method performed by a computer module monitors, for a large scale data storage system, system workload and I/O requests handling analytics (logs) on all levels of the system to use the workload and the I/O requests for monitoring system health and for determining the possibility of anomalies in system behavior.

Prediction of anomalies is based on use of a neural network to process an input vector. The makeup of the input vector is described in greater detail below. The neural network is trained on large amounts (e.g., hundreds of thousands) of various workloads and system I/O performance logs, anomalous or not, for each of the various workloads. The method, using the input vector and the neural network, is capable of predicting the existence of some anomalies with a confidence level relative to all anomalies for which the method is searching. The anomalies and how they affect the system functioning currently and in the future are described further herein.

Training of a neural network is known. In brief, a neural network is trained using gathered training data which is labeled with the classes of anomalies. Each entry of logs (specific to the process at hand, with embodiments of the present disclosure described further below) is processed and shaped into an input vector. For example only, consider the input vector to be a simple array of digits, 256 bytes in length. Each such array is labeled with the type of anomaly described by the entry (0−N). The type of anomaly at this stage as assigned to the entry is mostly the result of the work of an engineer identifying what anomaly was present given the specific descriptor. A total set of data contains hundreds of thousands of entries. Of those, about 20% is a test set that is not used in training. This test set is used for measurements of network precision and recall. Larger training sets provide more robust and nuanced detections when the neural network is properly trained.

The data gathered is divided into two parts in proportion, one part a training set, and one part a test set. In one example, the proportion may be 80% training set, 20% test set. The training set with known outcomes is fed into the neural network for training. In one embodiment, after each epoch of the training set is fed to the neural network, the test set is used for monitoring training performance of the neural network detection during the training process.

A training script is organized as a large iterative loop. A number of circles called “training epochs” is controlled by an engineer and depends on the network detection quality. The more epochs, the more training and potentially better results. A balance is often used between too few and too many epochs. With too few, the results are not adequate. With too many, overtraining may result, in which the neural network learns too well the anomalies of the training set, but then behaves poorly on new data not seen before. Overtraining, therefore, may result in a lack of generalization of the knowledge domain. During one epoch of training, all entries from the training set are fed into the network. The input layer of the network is organized in this example to be 256 neurons, the same number as the number of bytes one input vector has. Internal layers of the network change their weight coefficients layer by layer and eventually transfer it to the output layer having a size equal to the number of classes (e.g., anomaly types). The training then checks how accurate the output is by comparing the output with the input, and the coefficients of the internal layers are adjusted according to gradient back propagation routine before the next epoch of training. Back propagation during training of neural networks is known. In general, this is adjusting the neural network weights and biases (not shown herein for the sake of simplicity) based on derivatives of the loss function, where loss function is the measure of how the desired result is far from the real network output. The derivative of the loss function, that is used in training, is called a gradient. Updating the weights, as the name suggests, propagates from output layers back to the input layers of the neural network.

A detection process runs in a similar way. Once trained, the network is used for detection. For example, the network is provided a log entry (input vector) from a live production system. The log entry is shaped as discussed above. The output of the network may be, for example, 10 digits, and may include weights of all classes in percents. The sum is 1.0 (100%) and the largest percent indicates the most likely anomaly. It should be understood that multiple anomalies may be detected with different likelihoods.

With the above-described approach, embodiments of the present disclosure use a neural network for the prediction and confidence level of. Use of a neural network is innovative for at least the following reasons:

1) Using even 256 input neurons, corresponding to the length of the input vector, +50 internal layers (for example only) allows for the solving of a 50^{th} level polynomial in 256-dimensional space. This gives a great level of flexibility. Further, solving such a task without a neural network (for example even with polynomial calculations) is impossible because of sheer mathematical and computational complexity.

2) Comparing all of the possible interrelations and correlations of different data is not possible. It is difficult to determine even whether one or two data points are correlated given the complexity of modern systems. To determine what correlations there are between multiple data points and processes quickly rises to the level of impossible. The input vector of the present disclosure contains very different types of data within the descriptor. Without a neural network, it would not be possible to create a comparison function that determines among multiple potential anomalies what level of likelihood each anomaly has, relative to the others. Further, it would be impossible to distinguish between one level, say 0.53 of write amplification anomaly and another level of 0.4 of write amplification.

3) The result of the neural network prediction is not necessarily only one anomaly type. In fact, the neural network predicts confidence of all anomalies it is searching for. Such anomalies of which it is made aware. The neural network can predict write amplification with the confidence 0.6 and a software bug with the confidence 0.3 at the same time (with the other 8 anomalies in the example from above having only 0.1 confidence combined).

4) The neural network also, through training with large amounts of data, learns the file system itself, that is, what is important, what is not, and how inputs relate. For example, earlier layers in the neural network learn simple things, such as, the nodes of a processing graph can be connected in a particular way, or that a histogram can have a certain shape or set of shapes. Later layers learn how to combine these simple types of knowledge into a more complex notion, such as, only one shape of the histogram and only one type of connection in the processing graph can lead to a certain anomaly. In other words, once trained, the neural network's knowledge of the file system work logic can be reused for completely different tasks later. This may be carried out by using the earlier layers of the neural network with their accumulated general knowledge of the file system, and replace the later layers that make a conclusion for a particular task. For example, with some minor amount of tuning and re-training, the trained neural network may be modified to detect new types of anomalies perhaps only 500 entries instead of a full training set. Or, the network may be used for detecting fake test loads from real-world loads.

It should be understood that the architecture of the neural network is less important than its use. However, for very specialized systems, development of a new architecture, which is outside the scope of this disclosure, may be done. Different neural network architectures may also allow the system to obtain new values. Training of a neural network, and detection of patterns in neural network data, are known, and will not be described in further detail below, except in situations where use of the neural network is a part of the disclosure.

Creation of the input vector is described in further detail below. An innovative aspect of the present disclosure is the determination of what data is presented to the neural network. Packing the input vector, including multiple types of data is a feature of the various embodiments. In one embodiment, an input vector for a neural network to detect anomalies in a distributed data storage system of a large scale/enterprise system, includes inputs covering workload type, system behavior, histograms, and correlations. For example, one input vector form is [workload type+system behavior matrix+read/write histogram shape matrix+correlation matrix]. Each component of the input vector, and the reason for its inclusion, is described below.

Workload Types

Workload types are one characteristic of a system that are used for anomaly prediction. A current system workload is used for accompanying the request (e.g., input vector) to the neural network. The current system workload is used because what may be an anomaly for one workload is a normal behavior of the system for another workload. Workload types is a vector of digits [0 . . . N]. The basics for workload type are system behavior during the last N mins:

1. Mostly reads;

2. Mostly writes;

3. Mixed workload.

Workload detection is based on a number of I/O requests of a particular type (e.g., read or write) in various processing queues of the file system. Additionally, the current basic workload type is accompanied by additional properties, such as the block size, read/write speed, latencies, throughput, distribution of service time, etc. With this data added, there are a fixed number of workloads. For example:

Type 0—Small blocks reads with speed≤2 gigabytes (GB) per sec;

Type 1—Large blocks writes with speed≥2 GB per sec;

. . .

Type N— . . . Large blocks mixed workload with speed≥2 GB per sec.

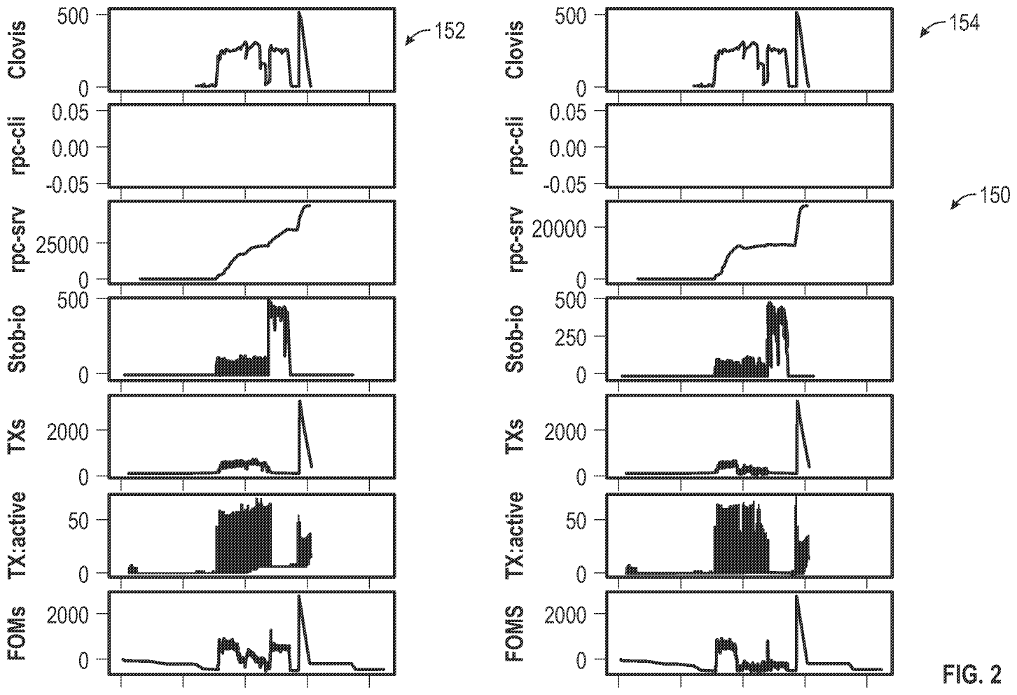

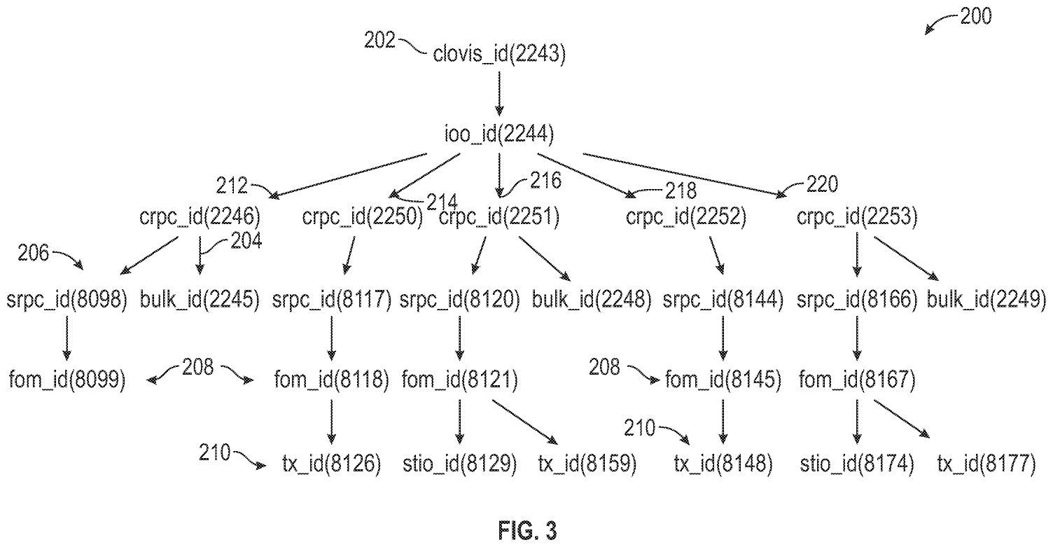

Examples of partially captured workload 150 can be seen in FIG. 2. The left 152 and right 154 columns correspond to servers in a 2-node network environment. The values on the axes are time in nanoseconds on the X-axis, and number of requests in flight for the given layer of the network stack on the Y-axis. Names of levels correspond to those shown in FIGS. 3-5.

Processing Graph

A second parameter for the input vector is an I/O request processing graph. A single write operation on one level (a level of a user application on a client node) typically results in multiple remote procedure calls (RPCs) sent to multiple different servers. Servers run multiple different request handling entities, which are, in one embodiment, elements of code that control how a RPC changes the state of storage, for example, and how it moves the state maching from one stage to another. In addition, the request handling entities may communicate with each other, which results in more requests and more request handling entities. Following that, flow control comes to block allocation and physical writes on storage media (e.g., hard disc drive (HDD), solid state drive (SSD), hybrid drives).

The resulting control flow can be depicted as a graph with some number of levels and nodes. An example processing graph 200 is shown in FIG. 3, which shows related subrequests and identifiers, as well as nodes and parent and child dependencies thereof. It should be understood that FIG. 3 shows only an example. Processing graphs for large systems can be much larger and more complex than the graph shown in FIG. 3. The processing graph 200 describes the reaction of the system on a typical I/O request 202. For example, in graph 200, each level (e.g., levels 204, 206, 208, 210) and node (e.g., 212, 214, 216, 218, 220, and so forth) has analytics related to the time of processing, lock contention, and time spent in the block allocator. This graph is the reaction of the system to an event such as user write operation on the system input. When a system has an available processing graph, it is then transformed into a behavior matrix and used as part of the input vector both for training and predicting with the neural network.

Processing graphs assist in the detection of certain types of anomalies, such as but not limited to software bugs.

Reads/Write Histograms

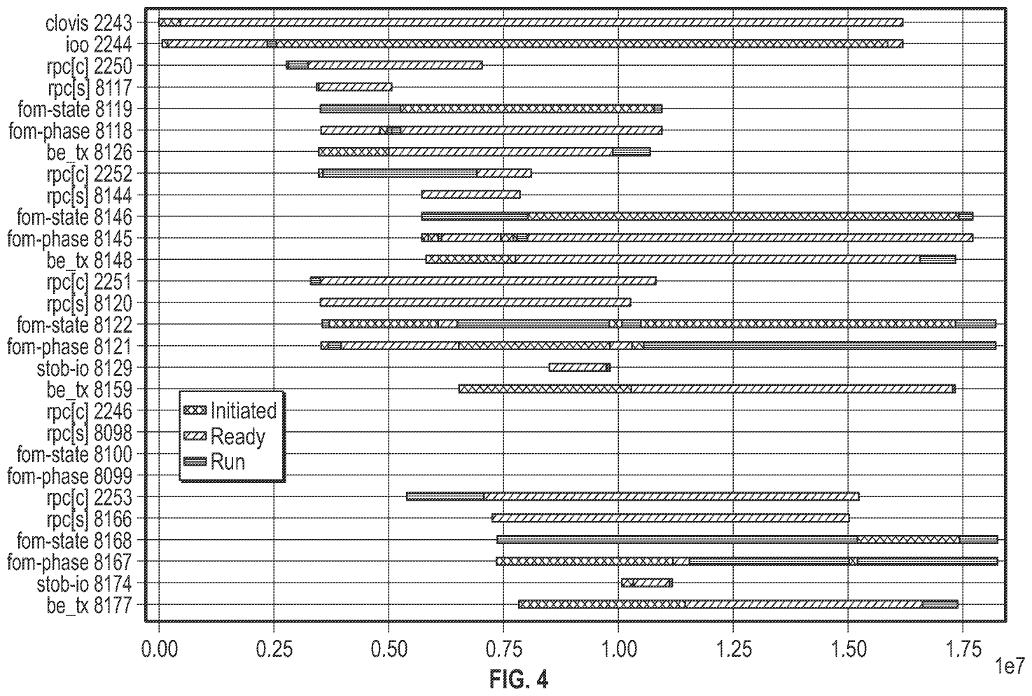

For each root request to the system, such as the write operation described above with respect to FIG. 3, the system can build a histogram of reads and writes on a lower level of the system (a storage object level, or STOB). This happens shortly before the operating system I/O scheduler and HDD operation. A timeline of sub-requests for a single command is shown in FIG. 4. Each sub-request has a processing time, and all the timelines of the sub-requests may be related to the original request.

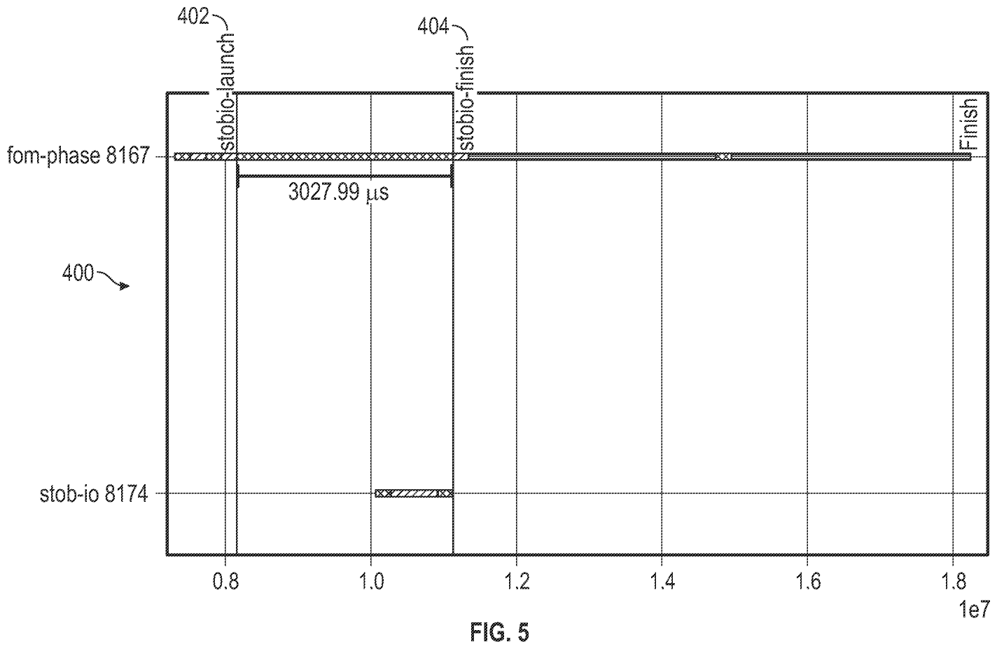

Histograms can be used to show relations between time distributions. The single request graph of FIG. 4 is shown from a client state machine (line 1, clovis 2243) and ends with a state machine of the transaction. In between, there are time distributions for each sub-request. For example, a single sub-event 400 is shown in graphical form in FIG. 5. The sub-event 400 shows a timeline on the X-axis for fom-phase 8167, with storing starting at launching of a storage object event (stobio-launch) 402. The sub-event finishes at stobio-finish 404. The time for completing the single stobio event is shown as about 3 milliseconds (ms) in this request to complete the I/O operation. This time is gathered for all iterations related to the workload, and a histogram for this sub-event may be created from the data.

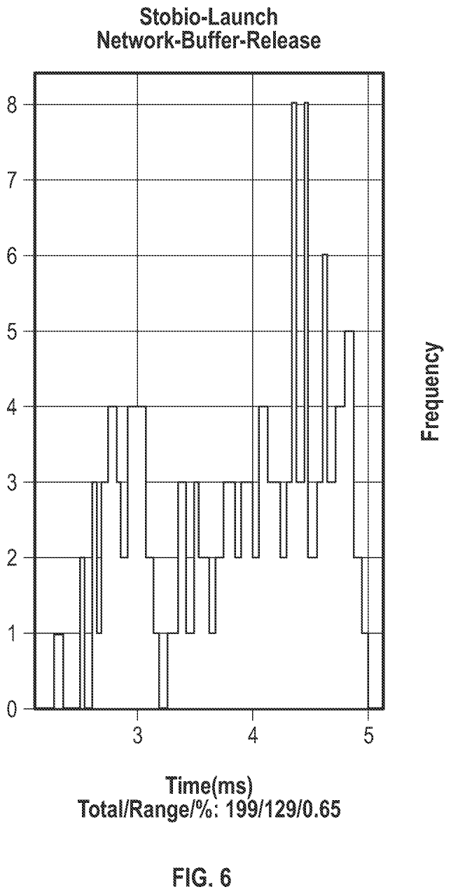

A representative histogram for this sub-event is shown in FIG. 6. It shows the operating time in ms and the frequency at which the time occurred for a workload. Using the histogram for this particular sub-event tells some things, such as whether a request was completed within a certain deviation from a median time, but the real work is performed by the neural network looking at histograms for all relevant sub-events as a component of the input vector, and finding correlations. From the single histogram of FIG. 6, a viewer can understand what this time distribution is, and can compare that with an individual parameter.

Histograms can be thought of as a two-dimensional plot with the Y-axis indicating a number of I/O requests and the X-axis indicating a time of processing. Each histogram provides the opportunity to use some techniques of distribution analysis, such as moments, in system analysis. A representative histogram is shown in FIG. 5.

An example use showing issues found with histogram analysis is described below. Normal functioning of a process will typically look like a normal distribution (e.g., a Gaussian distribution). Any substantial change in the shape of a curve may indicate a serious change in the functioning of a storage drive in the system. A longer but not heavy tail may indicate that some number of requests, for example 10%, have substantially longer (2-5× longer) time of processing. This may indicate issues with the storage drive, for example that the drive is nearing its end of life.

The generated histogram allows for the detection of some issues in I/O processing and also can be used for the monitoring of the health of the system. The shape of the histogram is another addition to the entity to be used for neural network prediction. Read/write histograms assist in the detection of certain types of anomalies, such as but not limited to HDD related issues.

Simply comparing values such as mean value, minimum/maximum time, standard deviation, etc. does not show much. However, when interrelated requests and operations are also considered, real patterns can be found. This is where the correlation matrix comes into play.

Correlation Matrix

Since the system is gathering a processing graph for all the I/O requests along with the processing time analytics on the corresponding files system levels (as shown in read/write histograms), all the information may be used for more powerful analysis of correlations between events to identify potential issues.

For example, processing times on different levels of the graph of FIG. 3 have some correlation. The embodiments of the present disclosure build a matrix of the correlation of each event with all other events, and use the correlation matrix for prediction of the system's health. Since correlation changes do not necessarily mean immediate issues in the system, those changes may be a sign of something wrong going on underneath in the system, and assist in creating a tool for forecasting issues long before they happen.

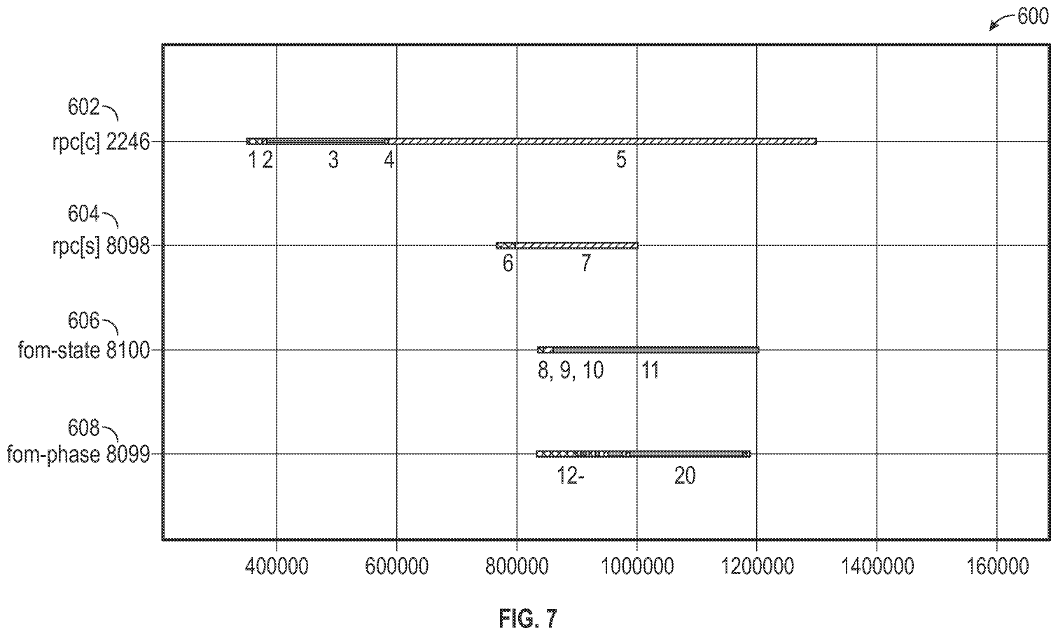

Referring now to FIG. 7, some of the information that is used to create a correlation matrix is shown. FIG. 7 shows principal components of sub-requests for a single event. When all the parameters for the sub-requests are determined, a calculation may be made across the request of the various timelines for completion. In FIG. 7, for example, a number of time intervals are indicated with numbers, specifically time intervals 1, 2, 3, 4, and 5 on line 602; time intervals 6 and 7 on line 604; time intervals 8, 9, 10, and 11 on line 606; and time intervals 12-20 on line 608. With the principal components of sub-requests determined, each time interval may correlate with any other time interval.

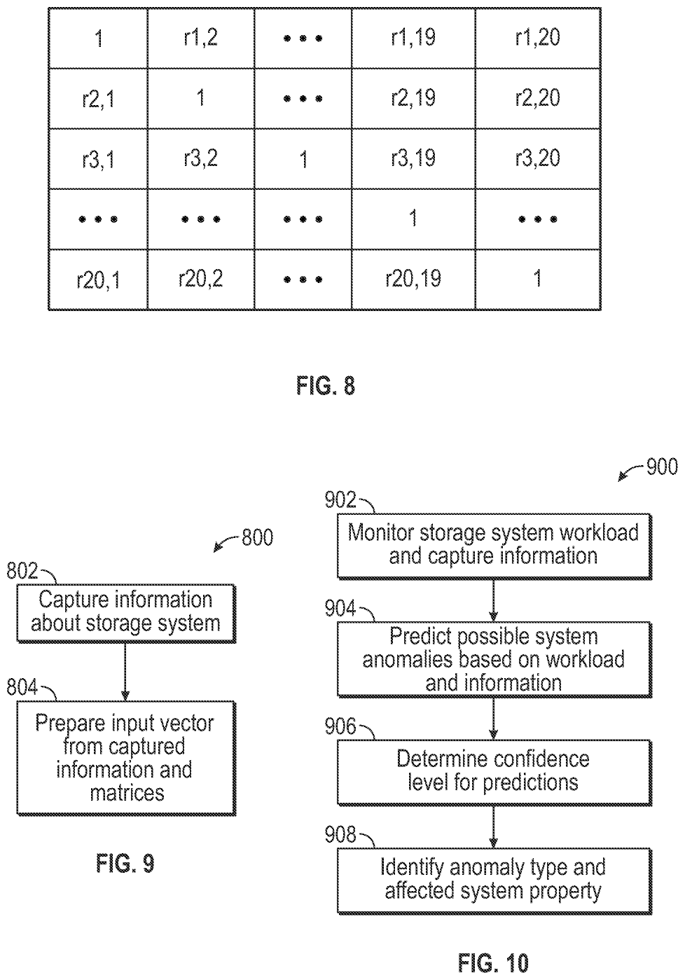

A correlation matrix determines the correlation between each time interval and each other time interval. With 20 intervals, a representative correlation matrix is shown in FIG. 8. The correlation matrix is the characteristics of the workload, and it can be compared with different characteristics for different workloads, current workload, etc.

Calculation of correlations is known and will not be further described herein. In one embodiment, correlation coefficients are determined using standard Pearson correlation calculations. The correlation coefficients may be used as entries into the input vector.

Each of the above referenced inputs are components of the input vector. That is, vectors for workload type [WT], processing graph as transformed to system behavior matrix [BM], read/write histograms transformed to shape matrix [RWHM], and correlation matrix [CM] are combined to form an input vector for the neural network of the form [WT+BM+RWHM+CM]

Accordingly, a method 800 of preparing an input vector for a neural network is shown in FIG. 9. Method 800 comprises, in one embodiment, capturing a plurality of information about a storage system, including workload types, a processing graph, and read/write histograms in block 802. Once the information is captured, the input vector is prepared in block 804. The input vector includes a workload vector representing the workload types, a behavior matrix representing the processing graph, a read/write histogram shape matrix representing the read/write histograms, and the correlation matrix.

Another method 900 is shown in block diagram in FIG. 10. Method 900 comprises, in one embodiment, monitoring a storage system workload and capturing storage system information including workload types, a processing graph, read/write histograms, and input/output performance in block 902. The method further includes predicting possible storage system anomalies based on the storage system workload and storage system information in block 904. A confidence level for the predicted possible anomalies is identified in block 906, and a type of anomaly for the predicted possible anomalies, and an affected system property for the predicted anomalies is identified in block 908.

Anomalies may be detected using the input vector processed through a neural network. Anomalies may further be broken into a determined number of types, and wherein the neural network identifies each potential anomaly with a confidence range between 0 and 1, wherein a sum of the confidence ranges of all anomalies is 1, as described further below.

An example method as performed above may result in a set of anomalies and predictions related thereto. For example only, a method may result in the following set of anomalies after consideration by the neural network.

1. Type 0—No anomalies

2. Type 1—Write amplification—the HDDs write too much, (SSD remapping often), etc. This results in quality of service (QoS) issues. Potentially can cause failure of the HDD. Alarm level—low;

3. Type 2—Processing graph change—possible file system bug. Alarm level—high;

4. Type 3—Reads/Writes Histogram shape changed—HDD issues. Alarm level —medium;

5. Type 4—Block allocator increased fragmentation. QoS issues. Alarm level —medium;

6. Type 5—Correlation matrix issues. The system is undergoing serious issues in workload handling. Alarm level—medium but only because this is the sign of something bad in quite a distant future and there is a substantial amount of time to determine what is wrong.

Example of the module prognosis:

Anomaly type=WRITE AMPLIFICATION

Confidence=0.85 (85%)

Affected system property=QoS

The neural network type is a classifier since it returns only types of possible anomalies with confidence. A representative output vector from the neural network with an input vector as described herein is shown in Table 1.

TABLE 1

| | Confidence | |
|---|---|---|
| Anomaly type | (range 0-1.0) | Description |
| Type 0 | .15 | No anomaly, too low confidence |
| Type 1 | .02 | Write amplification, too low |
| | | confidence |
| Type 2 | .78 | Processing graph issue, high |
| | | confidence |
| Type 3 | .02 | Too low confidence |
| Type 4 | .02 | Too low confidence |
| Type 5 | .01 | Too low confidence |

In this example, the neural network output, given the input vector, detected anomaly of Type 2, processing graph issues with high confidence. With high probability, therefore, the method predicts a software bug.

Embodiments of the present disclosure may be a system, a method, and/or a computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational processes to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of preparing an input vector for a neural network, comprising:
capturing a plurality of information about a storage system, including workload types, a processing graph, and read/write histograms;
creating a correlation matrix from processing times of different levels of processes in a workload of the storage system; and
preparing the input vector with a workload vector representing the workload types, a behavior matrix representing the processing graph, a read/write histogram shape matrix representing the read/write histograms, and the correlation matrix.

2. The method of claim 1, wherein the workload types are determined by a behavior of the storage system for a predetermined time period before preparation of the input vector.

3. The method of claim 2, wherein the workload types comprise mostly read operations, mostly write operations, or a mixed workload of read and write operations; block size; and read/write speed; and wherein the workload types are transformed into a workload vector as an input to the input vector.

4. The method of claim 1, wherein the processing graph comprises an input/output (I/O) request processing graph describing a reaction of the storage system to an I/O request, comprising levels, nodes, and interactions, and wherein the processing graph is transformed to a behavior matrix as an input to the input vector.

5. The method of claim 1, wherein each read/write histogram of the read/write histograms comprises a histogram of read or write operation history versus processing time, and wherein the read/write histograms for different operations are used to generate a read/write histogram shape matrix, which is provided as an input to the input vector for the specific read or write operation.

6. The method of claim 1, wherein the correlation matrix comprises a correlation matrix of processing times for each process versus each other process in the storage system, and wherein the correlation matrix is provided as an input to the input vector.

7. The method of claim 1, wherein:
the workload types comprise mostly read operations, mostly write operations, or a mixed workload of read and write operations; block size; and read/write speed; and wherein the workload types are transformed into a workload vector as an input to the input vector;
the processing graph comprises an input/output (I/O) request processing graph describing a reaction of the system to an I/O request, comprising levels, nodes, and interactions, and wherein the processing graph is transformed to a behavior matrix as an input to the input vector;
the read/write histogram comprises a histogram of read and write operation history versus processing time, and wherein the read/write histograms for different operations are used to generate a read/write histogram shape matrix, which is provided as an input to the input vector for the specific operation; and
the correlation matrix comprises a correlation matrix of processing times for each process versus each other process in the system, and wherein the correlation matrix is provided as an input to the input vector.

8. The method of claim 7, wherein the input vector comprises vector entries for the workload types, the behavior matrix, the read/write histogram shape matrix, and the correlation matrix.

9. The method of claim 8, wherein anomalies of the storage system are detected using the input vector processed through a neural network.

10. The method of claim 9, wherein the anomalies are broken into a determined number of types, and wherein the neural network identifies each potential anomaly with a confidence range between 0 and 1, wherein a sum of the confidence ranges of all anomalies is 1.

11. A method, comprising:
monitoring a storage system workload and capturing storage system information including workload types, a processing graph, read/write histograms, and input/output performance;
predicting possible storage system anomalies based on the storage system workload and storage system information;
identifying a confidence level for the predicted possible storage system anomalies; and
identifying a type of anomaly for the predicted possible anomalies, and an affected system property for the predicted anomalies.

12. The method of claim 11, wherein the workload types comprise mostly read operations, mostly write operations, or a mixed workload of read and write operations; block size; and read/write speed; and wherein the workload types are transformed into a workload vector as an input to the input vector.

13. The method of claim 11, wherein the processing graph comprises an input/output (I/O) request processing graph describing a reaction of the storage system to an I/O request, comprising levels, nodes, and interactions, and wherein the processing graph is transformed to a behavior matrix as an input to the input vector.

14. The method of claim 11, wherein each read/write histogram of the read/write histograms comprises a histogram of read or write operation history versus processing time, and wherein the read/write histograms for different operations are used to generate a read/write histogram shape matrix, which is provided as an input to the input vector for the specific read or write operation.

15. The method of claim 11, wherein the correlation matrix comprises a correlation matrix of processing times for each process versus each other process in the storage system, and wherein the correlation matrix is provided as an input to the input vector.

16. The method of claim 11, wherein:
the workload types comprise mostly read operations, mostly write operations, or a mixed workload of read and write operations; block size; and read/write speed; and wherein the workload types are transformed into a workload vector as an input to the input vector;
the processing graph comprises an input/output (I/O) request processing graph describing a reaction of the system to an I/O request, comprising levels, nodes, and interactions, and wherein the processing graph is transformed to a behavior matrix as an input to the input vector;
the read/write histogram comprises a histogram of read and write operation history versus processing time, and wherein the read/write histograms for different operations are used to generate a read/write histogram shape matrix, which is provided as an input to the input vector for the specific operation; and
the correlation matrix comprises a correlation matrix of processing times for each process versus each other process in the system, and wherein the correlation matrix is provided as an input to the input vector.

17. The method of claim 16, wherein the input vector comprises vector entries for the workload types, the behavior matrix, the read/write histogram shape matrix, and the correlation matrix.

18. The method of claim 17, wherein anomalies of the storage system are detected using the input vector processed through a neural network, and wherein anomalies are broken into a determined number of types, and wherein the neural network identifies each potential anomaly with a confidence range between 0 and 1, wherein a sum of the confidence ranges of all anomalies is 1.

19. A non-transitory computer-readable storage medium including instructions that cause a data storage device to:
capture a plurality of information about a storage system, including workload types, a processing graph, and read/write histograms;
create a correlation matrix from processing times of different levels of processes in a workload of the storage system; and
prepare the input vector with a workload vector representing the workload types, a behavior matrix representing the processing graph, a read/write histogram shape matrix representing the read/write histograms, and the correlation matrix.

20. The non-transitory computer-readable storage medium of claim 19, wherein the instructions further cause the data storage device to detect anomalies of the storage system using the input vector processed through a neural network, and wherein anomalies are broken into a determined number of types, and wherein the neural network identifies each potential anomaly with a confidence range between 0 and 1, wherein a sum of the confidence ranges of all anomalies is 1.
